(19) United States
(12) Patent Application Publication
(10) Pub. No.: US 2014/0039792 A1
(43) Pub. Date: Feb. 6, 2014

(54) METHOD AND APPARATUS FOR PRESENTING MULTIMEDIA INFORMATION IN ASSOCIATION WITH A ROUTE

(71) Applicant: Sriram Seetharam, Chelmsford, MA (US)

(72) Inventor: Sriram Seetharam, Chelmsford, MA (US)

(73) Assignee: Nokia Corporation, Espoo (FI)

(21) Appl. No.: 13/564,442

(22) Filed: Aug. 1, 2012

(51) Int. Cl. G01C 21/00

(52) U.S. Cl. 701/538; 701/400

(57) ABSTRACT

An approach for enabling a user to view multimedia information associated with a route is described. A route based multimedia generator determines an input for selecting at least one route associated with at least one device. The route based multimedia generator further determines multimedia information associated with the at least one route. The route based multimedia generator further causes, at least in part, a presentation of the multimedia information in place of mapping information, navigation information, or a combination thereof associated with the at least one route.

### BACKGROUND

Service providers and device manufacturers (e.g., wireless, cellular, etc.) are continually challenged to deliver value and convenience to consumers by, for example, providing compelling network services. One area of interest is providing device users with on demand access to maps and routing information such as routes and points-of-interest (POI) data. Typically, device users rely on global positioning tools and associated navigation applications as a means of acquiring routing and mapping information. However, in cases where a particular route is frequently travelled by the user, the user may be compelled to completely ignore the routing and mapping information. Alternatively, the user may opt to exit the navigation application or not even initiate the application in the first place due to the redundancy of the information. Unfortunately, users are limited in their ability to view relevant information pertaining to a route without reliance upon or in connection with navigation or mapping information.

### SOME EXAMPLE EMBODIMENTS

Therefore, there is a need for enabling a user to view multimedia information associated with a route.

According to one embodiment, a method comprises determining an input for selecting at least one route associated with at least one device. The method also comprises determining multimedia information associated with the at least one route. The method further comprises causing, at least in part, a presentation of the multimedia information in place of mapping information, navigation information, or a combination thereof associated with the at least one route.

According to another embodiment, an apparatus comprises at least one processor, and at least one memory including computer program code for one or more computer programs, the at least one memory and the computer program code configured to, with the at least one processor, cause, at least in part, the apparatus to determine an input for selecting at least one route associated with at least one device. The apparatus is also caused to determine multimedia information associated with the at least one route. The apparatus is further caused to cause, at least in part, a presentation of the multimedia information in place of mapping information, navigation information, or a combination thereof associated with the at least one route.

According to another embodiment, a computer-readable storage medium carries one or more sequences of one or more instructions which, when executed by one or more processors, cause, at least in part, an apparatus to determine an input for selecting at least one route associated with at least one device. The apparatus is also caused to determine multimedia information associated with the at least one route. The apparatus is further caused to cause, at least in part, a presentation of the multimedia information in place of mapping information, navigation information, or a combination thereof associated with the at least one route.

According to another embodiment, an apparatus comprises means for determining an input for selecting at least one route associated with at least one device. The apparatus also comprises means for determining multimedia information associated with the at least one route. The apparatus further comprises means for causing, at least in part, a presentation of the multimedia information in place of mapping information, navigation information, or a combination thereof associated with the at least one route.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling a user of a device to view multimedia information associated with a route, according to one embodiment;

FIG. 2 is a diagram of the components of a route based multimedia generator, according to one embodiment;

FIGS. 3A-3E are flowcharts of processes for enabling a user of a device to view a location from different fields-of-view, according to various embodiments;

FIGS. 4A-4C are diagrams of user interfaces utilized in the processes of FIGS. 3A-3E, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for enabling a user of a device to view multimedia information associated with a route are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

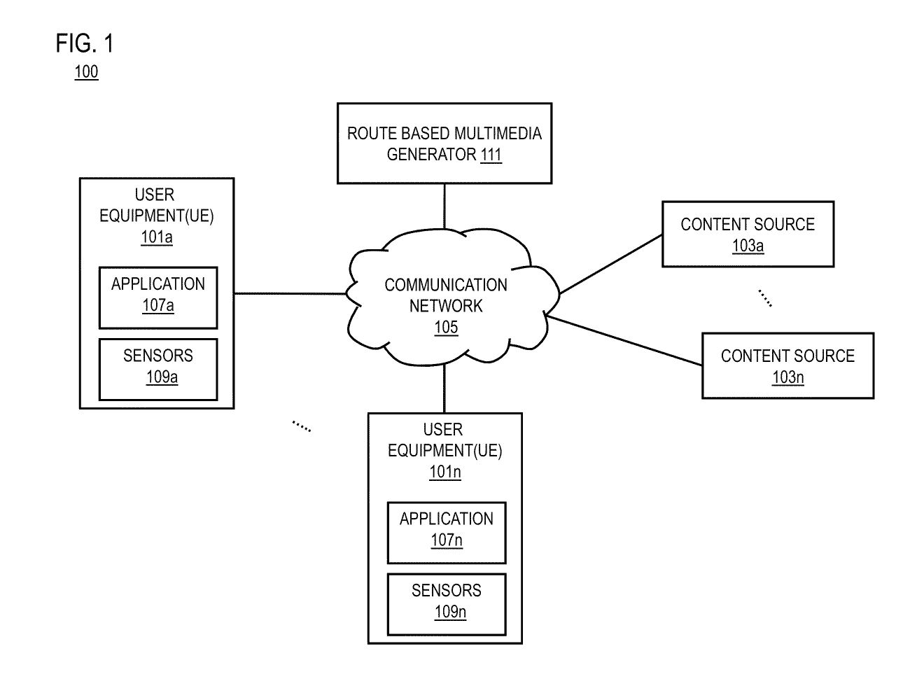

FIG. 1 is a diagram of a system capable of enabling a user of a device to view multimedia information associated with a route, according to one embodiment. By way of example, a route based multimedia generator 111 is configured to gather and subsequently present content items pertaining to a route as the user travels along the route. As noted previously, device users regularly rely on routing applications and corresponding services to access information regarding a route. For example, users may access maps for detailing the route, navigation directions, information regarding various points-of-interest (POI) such as landmarks and shopping centers they may encounter, etc. Typically, the routing information is visually depicted as various lines or objects juxtaposed against a map of a target location/region. In addition, various textual elements and icons may be presented in connection with different POI on a map to depict promotion information such as advertisements, coupons or product information.

Unfortunately, the promotion information is generally presented as secondary rather than primary information when featured in connection with traditional navigation information. As a result, this limits the overall effectiveness of navigation applications as a means of presenting promotion information. Also, in cases where a particular route is frequently travelled by the user, the user may ignore the routing information as it is presented or executed (e.g., audio based navigation directions) or opt to exit the navigation application due to redundancy of the information. Hence, users are limited in their ability to be presented with relevant information regarding a selected route as an alternative to traditional navigation or mapping information.

To address this problem, a system 100 of FIG. 1 introduces the capability to generate a user interface for presenting multimedia information in place of mapping information, navigation information, or a combination thereof in connection with a route. By way of example, the system 100 includes a route based multimedia generator 111 that is configured to render the multimedia information to a display of a user device (e.g., user equipment 101a-101n) based on a selected route of travel of the user. In addition, the route based multimedia generator 111 enables the multimedia information to be scrolled or sequentially executed (e.g., timed playback) concurrent with the movement of the user along a route.

By way of example, the multimedia information may include an arrangement of video, audio, image and/or textual elements or content to be presented to a user of a device relative to a route. The multimedia information may convey one or more advertisements, coupons, incentives, products, venue descriptions, user interest items or any other information pertinent to the user, the route or a combination thereof. Also, the arrangement, sequencing and execution of the video, audio, image and/or textual elements comprising the multimedia information may be based on the duration of the route, the location of the route, a travel modality associated with the user along the route or other factors.

For the purpose of illustration, the advertisements, coupons, incentives, products, venue descriptions, user interest items, etc., that comprise the multimedia information are referred to herein as location based items. It is noted that the location based items may be synonymous with various points-of-interest (POI) located along and/or within proximity of the route.

In certain embodiments, the route based multimedia generator 111 is configured to operate in connection with various user devices, i.e., user equipment (UE) 101a-101n. The UE 101a-101n may be any mobile or non-mobile computing devices for rendering (e.g., presenting and/or executing) multimedia information. For example purposes, UE 101a-101n is referred to collectively herein as UE 101. In addition, the UE 101 may belong to or be associated with respective users that are registered to interact with the route based multimedia generator 111 via a communication network 105. Alternatively, the route based multimedia generator 111 may operate directly at UE 101 via a calling application 107a-107n, referred to herein collectively as application 107. The route based multimedia generator 111 may therefore execute various application programming interface executions and the like for rendering multimedia information at a requesting UE 101 accordingly.

In certain embodiments, the route based multimedia generator 111 determines an input provided by a user of UE 101 corresponds to a selection of a route. Under this scenario, the application 107 may feature various input and selection options for defining the route. Alternatively, the route may be input/selected by the user via another application or service of the UE 101, such as a mapping or routing application. Under the latter scenario, the input provided at the mapping or routing application is fed to the route based multimedia generator 111. It is noted, therefore, that the route based multimedia generator 111 may operate in connection with a standalone application 107 or be integrated for use with another application and/or service (e.g., a mapping application). In the latter scenario, the route based multimedia generator 111 may provide an additional or alternate viewing experience of the user for interaction with the application 107—i.e., “Multimedia Information View” versus “2D Map View” or “Turn-By-Turn Directions View.”

By way of the example, the input/selection determined by the generator 111 may correspond to a route that is frequently travelled by the user. As such, the point of origination and final destination point may be previously defined by the user, i.e., via a navigation or mapping application. For example, frequented routes may include a route from the user's home to their place of work, from the user's home to the home of a friend or relative, from the user's place of work to a gymnasium, etc.

In certain embodiments, the route based multimedia generator 111 processes context information gathered by sensors 109a-109n, referred to herein collectively as sensors 109. By way of example, the context information may include location information, timing information, position information, speed information, etc. The location and position information may be used to determine a current heading of the user as well as for referencing the current location of the UE 101, different points-of-interest (POI) or other location based items relative to the route. Still further, the timing and speed information may be processed by the route based multimedia generator 111 to determine a current or predicted location of a given POI relative to the route.

Also, in certain embodiments, the context information is used by the route based multimedia generator 111 to identify and retrieve multimedia information (or location based items thereof) pertaining to the route. For instance, a selected route may encompass different streets, roads, highways, towns, cities, etc. In addition, various POI including businesses (e.g., restaurants, convenience stores), landmarks, local attractions, vendors and the like may be positioned along or within proximity of the route. Under this scenario, the route based multimedia generator 111 analyzes the context information to determine which location based items are related to the different POI, the current location of the UE 101 or the route. The location based items may include advertisements, coupons or other information associated with different POI visible to or within range of the user along the route. Alternatively, the location based items may include general information to be conveyed regarding the route, such as historic information, location statistics, etc. The route based multimedia generator 111 compiles the location based items into multimedia information related to the route.

Context information pertaining to the user of UE 101 may also be processed as a means of identifying multimedia information (or location based items thereof). This may include user interest information specified via a profile generated for the user during a subscription process with the route based multimedia generator 111. Alternatively, the context information may be acquired from a social networking resource of the user, i.e., as specified via the user profile. Under the above described scenarios, the user interest information may indicate activities, preferences, products, subject matters and other items of interest to the user. Multimedia information featuring tags or other identifiers matching the user interest information may then be retrieved from the content sources 103 accordingly. It is noted that the multimedia information or location based items gathered by the generator 111 on the basis of user interest information may or may not be related to any POI, the selected path or the location of the user.

Still further, context information for indicating the current behavior or status of the user may be processed by the route based multimedia generator 111 as a means of identifying and retrieving relevant multimedia information (or location based items thereof). The behavior may pertain to an activity of the user or a mode of travel of the user. For example, in the case where the user is determined to be jogging along a selected route, advertisements related to jogging products may be retrieved from the various content sources 103. As another example, music content may be retrieved based on a determination that the user is on a train or that a Bluetooth headset of the user is active.

In certain embodiments, the route based multimedia generator 111 retrieves the multimedia information (or location based items thereof) from various content sources 103a-103n, referred to herein collectively as content sources 103. The content sources 103 may be provided by various vendors, merchants, retailers, media providers, advertisers or the like. As such, the content sources 103 may be specified via a list maintained by the generator 111 for referencing different advertisements, coupons and other types of location based items. It is noted, therefore, that the different content source providers may be subscribed with a provider of the route based multimedia generator 111. As such, the route based multimedia generator 111 may be employed as an intermediary service for provisioning multimedia information relative to a select user, route, location, points of interest, etc.

In certain embodiments, the route based multimedia generator 111 causes the rendering of the multimedia information in place of navigation information or mapping information for a selected route. For the purpose of illustration, the rendering pertains to the coordinated presentment and/or execution of the multimedia information as an alternative to a “Map View” or textual and/or audio based route directions (e.g., “Turn-By-Turn Directions View”). Rather, the “Map View” is replaced by a “Multimedia Information View,” wherein the multimedia information is presented to the user in connection with a selected travel route. As such, the generator 111 generates a user interface for presenting the multimedia information concurrent with active travel of the user along the selected route or relative to the selected route. In addition, the route based multimedia generator 111 generates various user interface elements for depicting a heading of the user, a direction of one or more points of interest associated with the multimedia information, textual instructions related to the presented multimedia information, or a combination thereof.

By way of example, a first user interface element may be presented for depicting a location and direction of a user relative to the selected route. The user interface element may be an arrow pointing in the direction in which the user is heading along the route. Alternatively, the user interface element may be an icon of a person, vehicle or other item oriented in the direction of travel of the user. As another example, a second user interface element may be presented for depicting a direction and instructions for reaching certain POI. For example, an arrow may be presented as pointing in a certain direction relative to the first user interface element (per the user) while featuring a caption indicating the distance the user is to travel (e.g., “Fred's Donuts only 100 meters away.”). Other user interface elements may include different action buttons for supporting user interaction with the multimedia information presented. Hence, it is noted that traditional mapping or navigation information, including graphical depictions of roadways, POI, or other elements need not be presented in connection with the multimedia information. Rather, the POI and other location based items are represented as multimedia information within the user interface.

In certain embodiments, the route based multimedia generator 111 enables synchronized and selective execution of multimedia information concurrent with user travel along a route. For the purpose of illustration, the synchronized execution pertains to a match between a rendering of the multimedia information and/or one or more location based items.

By way of example, the generator 111 may adapt a duration or time of rendering (e.g., presentment and/or execution) of the multimedia information based on context information regarding the UE 101. Under this scenario, speed information or timing information may be processed regarding the user to coordinate a rate of scrolling of the multimedia information and/or location based items within the user interface. Moreover, in the case of audio or video related location based items, the context information may be used as a means of triggering their execution. Under this scenario, the audio or video location based item is executed concurrent with a determined proximity or location of a corresponding POI to the user. By way of this approach, the multimedia information is rendered to the user commensurate with the physical proximity or presence of an associated POI along the route. Still further, the multimedia information is rendered such that the various location based items coincide with the user's ability to view the route and/or POI associated therewith.

In certain embodiments, the route based multimedia generator 111 generates updated multimedia information in response to updated context information. For example, in the case where it is determined the speed of the user along the route is increased, the duration of the multimedia information may be shortened. Under this scenario, the route based multimedia generator 111 may prevent the execution of certain location based items whose duration exceeds an estimated time of view/presence of the corresponding POI. As another example, certain location based items may be replaced with shorter versions to accommodate the shortened duration of travel along the route. It is noted that other conditional factors that affect user interaction along the route may also cause adaptation of the multimedia information and/or the location based items.

In certain embodiments, the route based multimedia generator 111 also determines an accessibility of the multimedia information and/or the location based items for a given route. The accessibility pertains to an availability, location or proximity of a given location based item/POI with respect to a particular travel condition or travel modality (e.g., walking, driving). By way of example, the route based multimedia generator 111 may present offers, advertisements and other location based items as a tapestry multimedia information only if a related POI is on the side of the street the user is traveling. Under this scenario, the generator 111 may account for one way streets, highways, no left turn conditions, etc. As another example, the location based items may only be presented when a defined temporal condition is met, such during business hours when a retailer/advertiser is open.

In one embodiment, the route based multimedia generator 111 enables user interact with the multimedia information and/or select location based items as they are presented to a display of the UE 101. By way of example, the interaction may be determined based on an input specifying a selection of a location based item. This input may be received, for example, as a touch input or keyboard input of the UE 101. Depending on the implementation and features of the UE 101 as well as the type of multimedia information presented, the interaction may include the initiating of a website associated with the location based item, (b) user initiated execution of a location based item, (c) initiating of a transaction associated with a location based item, (d) initiating a storing of a location based item or information related thereto, or (e) a combination thereof.

By way of example, in the case where the UE 101 operates a virtual wallet application, the route based multimedia generator 111 may facilitate the storing of location based items to the virtual wallet. This may include the calling of APIs for facilitating communication between the generator 111, the virtual wallet application and the corresponding content source. As another example, a touch input received in association with a given location based item as presented may be translated into a request for bookmarking the item for later review by the user. It is noted that the route based multimedia generator may be customized to support various intra application and/or external service operations.

By way of example, the route based multimedia generator 111 enables one or more of the following: (1) determine user selection of a route; (2) identify and retrieve one or more location based items and/or associated multimedia items associated with the selected route, the user, or a combination thereof; (3) cause a rendering of a user interface for depicting a scrolling of the one or more content items, a movement of the one or more content items, an execution of the one or more content items, or a combination thereof concurrent with a direction of travel of the user along the route, a movement of the user along the route, or a combination thereof; (4) enable user interaction with the multimedia information and/or location based items as presented in connection with a route. Of note, the route based multimedia generator 111 enables a user to be presented with relevant information related to a route as an alternative to or independent of traditional navigation and/or mapping information.

As shown in FIG. 1, the system 100 comprises user equipment (UE) 101 having connectivity to the route based multimedia generator 111 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, route based multimedia generator 111, applications 107 and content sources 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information.

The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

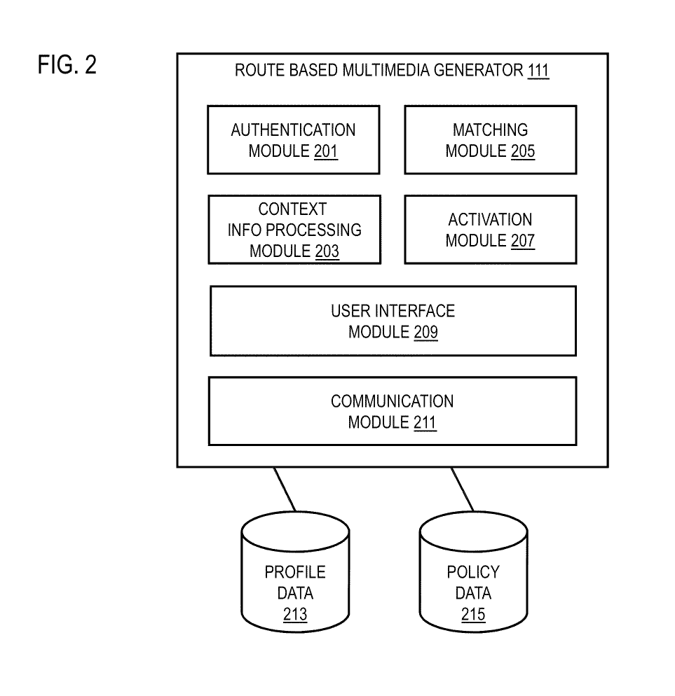

FIG. 2 is a diagram of the components of a route based multimedia generator, according to one embodiment. By way of example, the route based multimedia generator 111 includes one or more components for enabling a user to view multimedia information associated with a route. It is contemplated that the functions of these components may be combined in one or more components or performed by other components of equivalent functionality. In this embodiment, the route based multimedia generator 111 includes an authentication module 201, context information processing module 203, matching module 205, activation module 207, user interface module 209 and communication module 211.

The aforementioned modules 201-211 of the route based multimedia generator 111 may also access one or more databases 213 and 215 or resources (e.g., content sources 103a-103n) for performing various executions. This includes, for example, a policy database 215 for accessing various conditions of execution/rendering of location based for a given route. Also included is a profile database 213 for maintaining profile information related to one or more users subscribed to and/or associated with the route based multimedia generator 111. Profiles may also be maintained for different content source providers that subscribe with a provider of the generator 111.

In one embodiment, an authentication module 201 authenticates users and UE 101a-101n for interaction with the route based multimedia generator 111. In addition, the authentication module authenticates content source providers for interaction with the generator 111. By way of example, the authentication module 201 receives a request to subscribe to the route based multimedia generator 111 per a web based registration and/or subscription interface provided by the user interface module 213. The subscription process may include, for example, establishing one or more types of multimedia information and/or location based items to permit to be rendered at their respective UE 101. This includes enabling user activation of certain media types, such as audio, while further supporting deactivation of other types such as video. Subscription may also entail selection of an “opt-in” option, wherein users of the route based multimedia generator 111 permit the sharing of context information (e.g., location information, position information and temporal information) as collected via one or more sensors 109 of UE 101. Still further, the user may specify one or more user interest items, including various keywords or tags, a selection of various advertisement/location based item categories of interest, etc.

In the case of a content source provider, the subscription process may include specifying the network and/or database location of location based items and/or multimedia information to be presented to requesting UE 101. In addition, the subscription procedure may include the defining of policy data for supporting conditional execution of multimedia information relative to a determined route and/or contextual condition. It is noted that in the case of a user or content source provider, preferences and settings information may be maintained in connection with profile data 213. It is further noted, in certain embodiments, that the subscription process may be coordinated with a subscription process of a mapping or navigation service accessed by a user.

The authentication process performed by the module 201 may also include receiving and validating a login name and/or user identification value as provided or established for a particular user during a subscription or registration process with the service provider. The login name and/or user identification value may be received as input provided by the user from the user device 101 or other device via a graphical user interface to the route based multimedia generator 111 (e.g., as enabled by user interface module 209). Profile data pursuant to registration may be cross referenced as part of the login process. Alternatively, the login process may be performed through automated association of profile settings maintained as profile data 217 with an IP address, a carrier detection signal of a user device, mobile directory number (MDN), subscriber identity module (SIM) (e.g., of a SIM card), radio frequency identifier (RFID) tag or other identifier.

In certain embodiments, the matching module 205 determines an input for specifying user selection of a route. By way of example, the matching module 205 interfaces with a navigation and/or mapping application of a UE 101 to interpret a route input. In addition, the matching module 205 determines whether the route is frequented by the user, i.e., whether the route was previously defined by the user via the navigation and/or mapping application. Once the route is specified, the matching module 205 operates in connection with the context information processing module 203 to determine related multimedia information and/or location based items.

In one embodiment, the context information processing module 203 receives context information as gathered by the sensors 109a-109n of respective UE 101a-101n. Once received, the context information processing module 203 analyzes the context information 113 to determine the relative location, time, position and other information useful for identifying multimedia information and/or location based items related to a selected travel route. Based on this determination, the context information processing module 203 triggers execution of the matching module 205, which facilitates the querying/retrieval of associated multimedia information and/or location based items corresponding to the route. The matching module 205 may further call upon the communication module 211 to facilitate communication and data exchange with one or more (registered) content sources 103.

It is noted that the matching module 205 may also facilitate the generation of multimedia information. The generation procedure is performed by the matching module 205 in instances where no prior multimedia information exists for a selected route. In addition, the procedure may be performed in instances where a POI along a route no longer exists, requires updating, etc. Under this scenario, the matching module 205 sequentially coordinates and arranges different location based items to produce the multimedia information accordingly. It is noted that the matching module 205 generates the multimedia information based on the provided context information, thus accounting for location, duration, proximity and user related conditions.

It is noted, in certain embodiments, that the matching module 205 may facilitate various content rendering, blending, merging and other compilation techniques for producing multimedia information. Also, it is contemplated that the matching module 205 may be configured to operate in connection with an augmented reality application. For example, the field-of-view module 205 may retrieve real-time image data corresponding to the selected route or a POI, such as from a live camera feed, for supporting an augmented reality view. Under this scenario, the module 205 correlates the appropriate augmented reality view with the multimedia information retrieved from the various content sources.

In one embodiment, the activation module 207 enables a user to execute various additional features in connection with the presentment of multimedia information. By way of example, the activation module 207 may interface with a virtual wallet application for enabling the storing of offers, coupons and other incentives presented to the user as multimedia information. As another example, the activation module 207 may interface with a task list application or calendar application for enabling the association of multimedia information with scheduled time or activity. Still further, the activation module 207 may interface with a multimedia player for supporting the execution of media content, i.e., playback of an advertisement as the user travels along the route. It is noted that the module 207 may operate in connection with the user interface module 209 for executing various APIs of the above described applications.

Still further, the activation module 207 may operate in connection with the matching module 205 and context information processing module 203 to time the execution multimedia content with respect to the route. This may include, for example, determining to execute audio location based items only when the user reaches a certain location along the route. Alternatively, the module 207 may activate the presentment of the content a number of seconds before the user approaches a given POI or when it is determined the POI is within a field-of-view of the user. Under this scenario, an audio message pertaining to a bakery is timed for execution only when the user is within X feet of the bakery and/or on the correct side of the street.

Still further, the activation module 207 may facilitate progressive or staged execution of the multimedia information and/or location based items. By way of example, when the user stops along the route (e.g., at a red light), a longer video advertisement may be shown to account for the current proximity of the user to a corresponding POI. Alternatively, in the case where the user is moving at a greater pace along the route, a limited version of the video advertisement may be shown or, depending on the duration, may be replaced with a print advertisement. As such, content execution may be adapted accordingly to account for different contextual scenarios associated with the user. The activation module 207 accesses policy data 215 to facilitate the conditional execution of multimedia information and/or location based items accordingly.

In one embodiment the user interface module 209 enables presentment of a graphical user interface for presenting panoramic images in connection with a selected location. By way of example, the user interface module 209 employs various application programming interfaces (APIs) or other function calls corresponding to the application 107 of UE 101; thus enabling the display of graphics primitives such as menus, buttons, data entry fields, etc. Still further, the user interface module may operate in connection with the various other modules for coordinating, arranging and controlling the display of multimedia information. For example, the user interface module 201 may coordinate with the activation module 207 and context information processing module 203 in order to depict a scrolling of the multimedia information concurrent with a movement of the user along the route.

In one embodiment, a communication module 211 enables formation of a session over a network 105 between the route based multimedia generator 111 and the content sources 103 and UE 101. By way of example, the communication module 211 executes various protocols and data sharing techniques for enabling collaborative execution over the network 105.

The above presented modules and components of the route based multimedia generator 111 can be implemented in hardware, firmware, software, or a combination thereof. Though depicted as a separate entity in FIG. 1, it is contemplated that the route based multimedia generator 111 may be implemented for direct operation by respective UE 101. As such, the route based multimedia generator 111 generates direct signal inputs by way of the operating system of the UE 101 for interacting with the application 107. In another embodiment, one or more of the modules 201-213 may be implemented for direct operation with a service or application of the UE 101, such as in the form of a widget, applet or add on component. The various executions presented herein contemplate any and all arrangements and models.

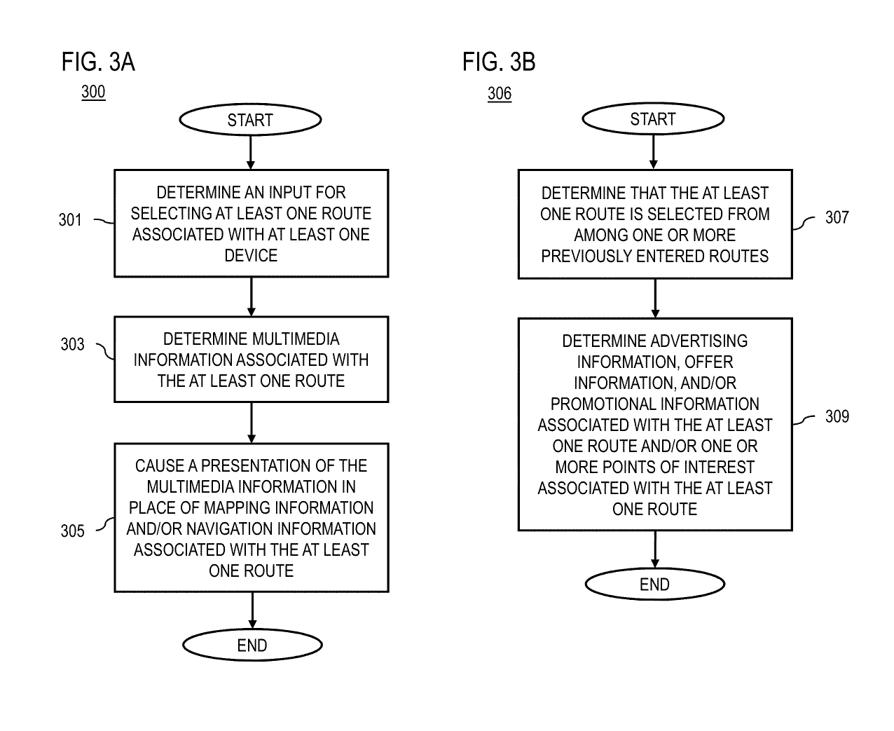

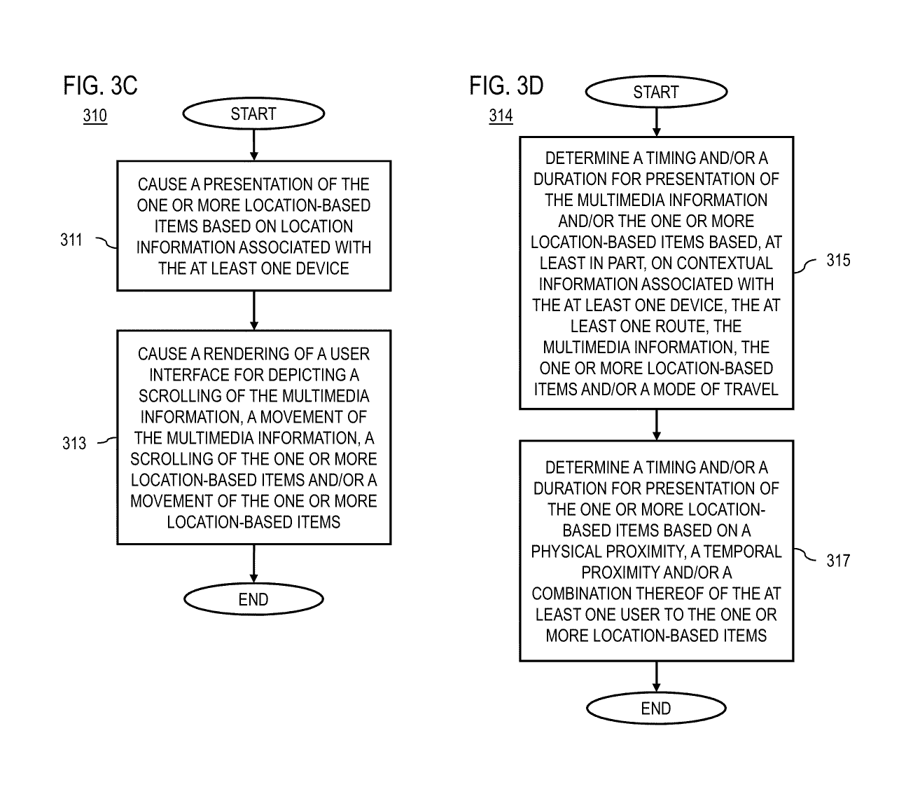

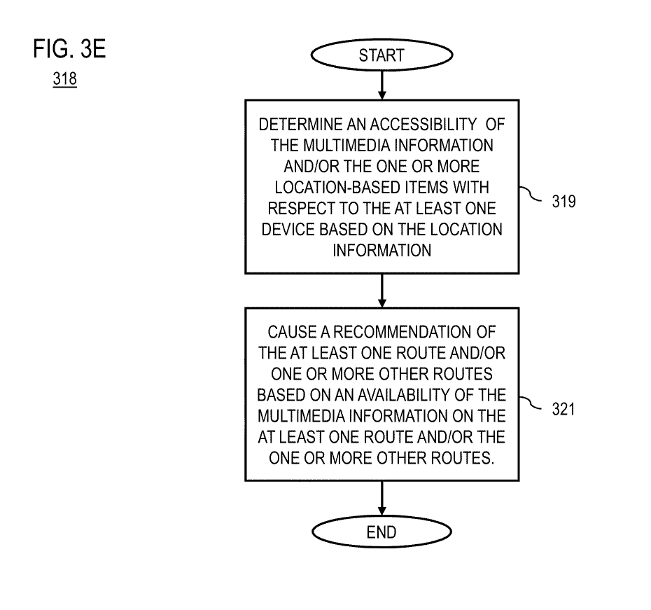

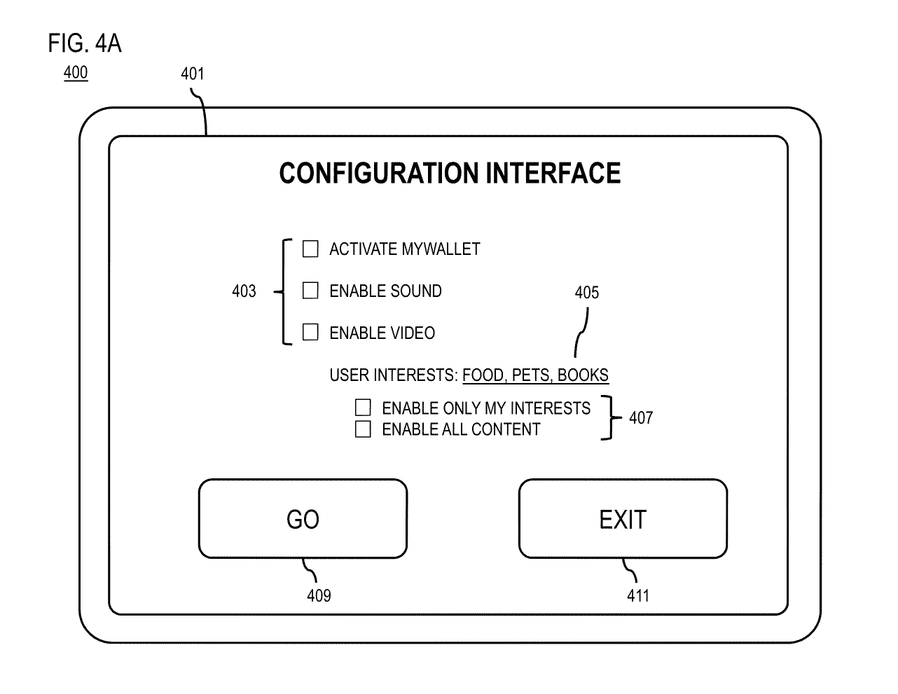

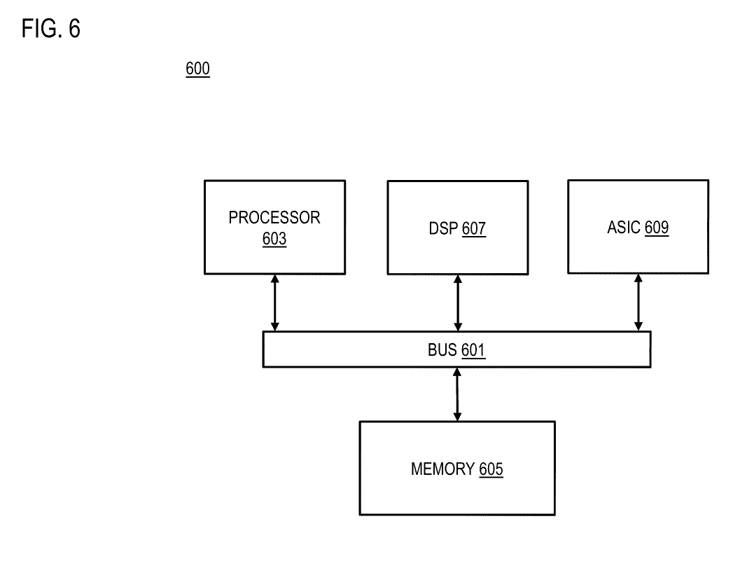

FIGS. 3A-3E are flowcharts of processes for enabling a user of a device to view a location from different fields-of-view, according to various embodiments. In one embodiment, the route based multimedia generator 111 performs processes 300, 306, 310, 314, and 318. Also, the route based multimedia generator 111 may be implemented in, for instance, a chip set including a processor and a memory as shown in FIG. 6.

In step 301 of process 300 (FIG. 3A), the route based multimedia generator 111 determines an input for selecting at least one route associated with at least one device. As noted previously, this input may be provided to or selected via a navigation or mapping application. Alternatively, in the case of a dedicated application 107 operating in connection with the route based multimedia generator 111, the route may be selected and/or defined via the application 107.

In step 303, the route based multimedia generator 111 determines multimedia information associated with the at least one route. In another step 305, the route based multimedia generator 111 causes, at least in part, a presentation of the multimedia information in place of mapping information, navigation information, or a combination thereof associated with the at least one route. As described previously, the presentation may correspond to user activation of a “Multimedia Information View” as opposed to a traditional map and/or navigation directions view of a given route.

In step 307 of process 306 (FIG. 3B), the route based multimedia generator 111 determines that the at least one route is selected from among one or more previously entered routes. Per step 309, the generator 111 determines advertising information, offer information, promotional information, user interest information, or a combination thereof associated with the at least one route, one or more points of interest associated with the at least one route, or a combination thereof. As noted, the advertising information, offer information, promotional information and/or user interest information comprise the multimedia information. Hence, the multimedia information represents a coordinated tapestry of information and media of different types to be executed in connection with the selected route.

In step 311 of process 310 (FIG. 3C), the route based multimedia generator 111 causes a presentation of the one or more location-based items based on location information associated with the at least one device. In another step 313, the generator 111 causes a rendering of a user interface for depicting a scrolling of the multimedia information, a movement of the multimedia information, a scrolling of the one or more location-based items and/or a movement of the one or more location-based items. Of note, the presentation of the multimedia information includes, at least in part, the rendering of the user interface; particularly, timed rendering of the multimedia information concurrent with physical movement of the user.

Per step 315 of process 314 (FIG. 3D), the route based multimedia generator 111 determines a timing, a duration, or a combination thereof for presentation of the multimedia information, the one or more location-based items, or a combination thereof based, at least in part, on contextual information associated with the at least one device, the at least one route, the multimedia information, the one or more location-based items, a mode of travel, or a combination thereof. Also, in step 317, the generator 111 determines a timing, a duration, or a combination thereof for presentation of the one or more location-based items based, at least in part, on a physical proximity, a temporal proximity, or a combination thereof of the at least one user to the one or more location-based items. It is noted, in certain embodiments, that the timing and/or duration may be calculated for predicting the presence, emergence and/or visibility of a certain point of interest/location based item along the route.

Per step 319 of process 318 (FIG. 3E), the route based multimedia generator 111 determines an accessibility of the multimedia information, the one or more location-based items, or a combination thereof with respect to the at least one device based, at least in part, on the location information. As noted, the accessibility may pertains to an availability, location or proximity of a given location based item/POI with respect to a particular travel condition or travel modality (e.g., walking, driving).

In step 321, the generator 111 causes, at least in part, a recommendation of the at least one route, one or more other routes, or a combination thereof based, at least in part, on an availability of the multimedia information on the at least one route, the one or more other routes, or a combination thereof. By way of example, the availability may pertain to the amount or type of multimedia information and/or location based items capable of being accessed from the content sources 103. Under this scenario, a route that includes a greater number or more types of multimedia information and/or location based items may be recommended as a route to a given destination more than a route featuring less information.

It is noted that the route based multimedia generator 111 overcomes limitations associated with traditional approaches to presenting information regarding a route. This includes, for example, enabling a view of multimedia information in place of traditional navigation and/or mapping information pertaining to a route.

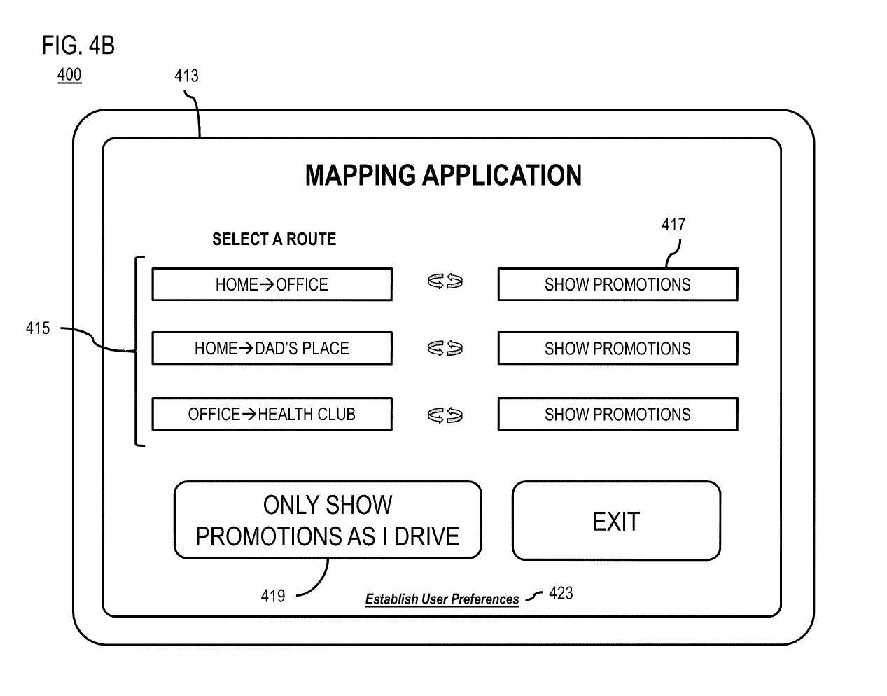

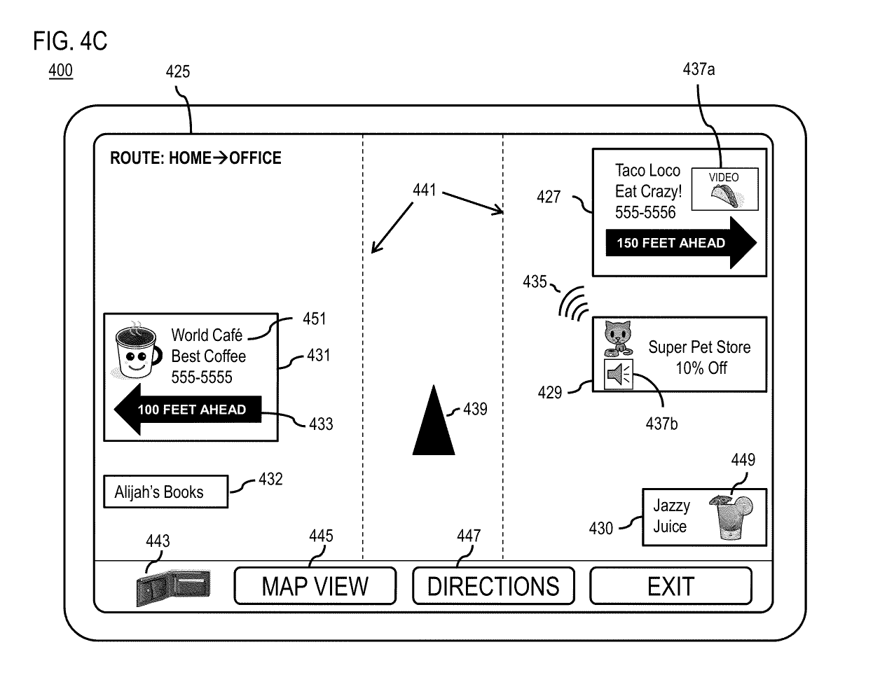

FIGS. 4A-4C are diagrams of user interfaces utilized in the processes of FIGS. 3A-3E, according to various embodiments. For the purpose of illustration, the diagrams are described with respect to an exemplary use case of a user interacting with the route based multimedia generator 111 via a mobile device (e.g., tablet device 400). In this example, the user is presented with multimedia information via a user interface in response to selection of a route via a mapping application, as depicted in FIG. 4B.

In FIG. 4A, the user is presented with a configuration interface of the route based multimedia generator 111. The configuration interface 401 presents various selection option for enabling the user to control the presentment of multimedia information and/or location based items with respect to a route. In addition, the interface 401 enables the user to define one or more interest items for influencing what multimedia information and/or location based items are rendered by the device 401 in connection with a route. By way of example, various checkbox options 403 may be activated for enabling the user to activate a virtual wallet application, enable the rendering of sound and enable the rendering of video based multimedia information.

The user may also define one or more user interests by typing one or more keywords in a user interest data entry field 405. Under this scenario, the user enters the keywords of “FOOD,” “PETS” and “BOOKS” for establishing an interest in multimedia information and/or location based items related to these subjects. As such, the route based multimedia generator 103 may query the various content sources 103 for data corresponding to these subjects and/or tags. In addition, the user is presented with additional checkbox options 407 for affecting the retrieval and/or generation of multimedia information, including an option to enable only user interest related multimedia information and/or location based items to be presented. As another option, the user may enable any type of multimedia information and/or location based items to be presented.

Once the selections are made, the user may select the GO action button 409 to enable the settings. Alternatively, the user may select the EXIT action button 411 to exit the configuration interface 401. It is noted that the configuration interface 401 may be accessed by way of a settings feature of the tablet device 401 or via a link/button (e.g., link 423 of FIG. 4B) of a mapping application operable by the device 401.

In FIG. 4B, the user is presented with various route selection options via a mapping application interface 413. By way of example, the route selection options 415 include a previously defined route from the user's home to their workplace (e.g., “HOME→OFFICE”), from the user's home to the home of their father (e.g., “HOME→DAD'S PLACE”) and from the user's workplace to their health club (e.g., “OFFICE→HEALTHCLUB”). Under this scenario, each of these routes represents those frequently travelled by the user or well known to the user.

Also presented to the interface 413 in connection with each route selection option 415 are show promotion options for enabling the showing of promotion information in connection with a given route. For example, the user may select the show promotion option 417 to enable rendering of promotion information such as advertisements and coupons concurrent with navigation and/or mapping information for the “HOME→OFFICE” route. This permits a traditional view of mapping and/or navigation information pertaining to the route along with the integration of some promotion information. Under this scenario, the promotion information is juxtaposed against the mapping and/or navigation information, thus presented as secondary or additional information.

Alternatively, the user may select the “ONLY SHOW PROMOTIONS AS I DRIVE” action button 419. Selection of this button 419 permits a non-traditional view of a selected route, wherein promotion information (in the form of multimedia information and/or one or more location based items) are primarily presented to the user during travel along the route. This corresponds to a “Multimedia Information View,” with other elements for depicting roadways, buildings, etc., being secondary. For this scenario, the user selects action button 419 as well as the route selection option for travelling from home to their workplace (e.g., “HOME→OFFICE), as depicted in FIG. 4C.

In FIG. 4C, a “Multimedia Information View” is presented as user interface 425 for depicting multimedia information pertaining to the selected route (e.g., “HOME→OFFICE”). By way of example, the multimedia information includes various location based items 427, 429, 430, 431 and 432. Under this scenario, the location based items correspond to different POI associated with the route and/or pertaining to the defined user interests (e.g., “FOOD,” “PETS” and “BOOKS” as per FIG. 4A). Each location based item may include a textual caption (e.g., caption 451) for conveying details about the location based item along with an associated icon/graphic (e.g., icon 449). The icon 449 may include a logo representing a certain business, product, or subject matter.

Also presented are various icons or frames for depicting an execution of a given location based item. For example, location based item 427 includes a frame 437a for depicting the availability of video content. As such, the user is made aware that the media type for this item 427 is video. According to the determined time, duration, and/or proximity information calculated for the user relative to the route (i.e., based on the collected context information), the video may be triggered for execution within the frame 437a as the user approaches this location based item/POI. The interface 425 may also receive a touch input at the frame for highlighting or expanding the frame 437a, thus permitting the user to further interact with the multimedia information.

As another example, icon 437b is shown with respect to location based item 429 for depicting the availability of audio content. As such, the user is made aware that the media type for this item 429 is audio. According to the determined time, duration, and/or proximity information calculated for the user relative to the route (i.e., based on the collected context information), the audio may be triggered for execution as the user approaches this location based item/POI. This is depicted by way of audio signal 435, which is an audio based advertisement related to a pet store. The interface 425 may also receive a touch input at the icon 437b for enabling volume control or various other playback/execution features of the audio, thus permitting the user to further interact with the multimedia information.

Also presented is a directional icon 439 for representing a location and direction of the user along the selected route. The directional icon 439 is positioned between the various location based items for depicting an orientation of the user along the route and relative to the different POI. An optional depiction of a roadway is presented as well, as defined by line segments 441, for indicating a current travel modality and position of user along the travel route. It is noted that the roadway may or may not be presented. Rather, the placement of the location based items relative to the directional icon 439 as multimedia information is sufficient to support user comprehension of the route, the corresponding POI along the route and the matching promotion information for each location based item. In addition, the user is able to comprehend that the view represents a two sided roadway. While not shown, the user may optionally view a single side of the roadway, such as in the case where the user is walking along a specific side of a roadway in the direction shown via icon 439.

Given the orientation of the directional icon 439, the placement of the different location based items along the route and the scrolling of the multimedia information due to continuous movement of the user (in the direction shown), the user may infer the following regarding the multimedia information:
(a) Passed Promotion Information—location based items 430 and 432 represent those which the user has already passed or is out of a predetermined proximity to. Consequently, in the case where any of the location based items were executable, the execution would cease once the user was out of range of the corresponding POI that the location based item represents.
(b) Current Promotion Information—location based items 431 and 429 represent those which are current as the user is approaching or within a predetermined proximity of. Consequently, in the case where any of the location based items are executable, the execution is performed accordingly or staged for execution concurrent with continued movement of the user along the route.
(c) Upcoming Promotion Information—location based item 427 represents that which the user is approaching with continued movement. Consequently, in the case where any of the location based items are executable, the execution is delayed until the user is within a predetermined temporal or location based proximity of the location based item 427.

It is noted that the location based items may be conveyed as audio guidance (e.g., text-to-audio) for the user during active travel along the route. Also, the route based multimedia generator 111 may prioritize certain location based items for execution over others in instances where competing items are presented in connection with the route relative to the location of the user (e.g., opposing/adjacent location based items/POI). The prioritization may be first-come-first-serve based, wherein the location based item that occurs first overrides execution of the other. Alternatively, the prioritization may be based on the media type, wherein a particular type overrides execution of another. Various other approaches for enabling rendering of the items may also be employed accordingly or as defined per one or more policies.

The user is also presented with an arrow for depicting a direction and/or distance of a given location based item from the user. For example, arrow 433 is presented in connection with location based item 431 for conveying to the user that the World Café is 100 feet ahead in the direction of the arrow 433. Also presented in a wallet icon 433 for enabling user entry and/or storing of various location based items or information related thereto. For example, the user may perform a touch based drag input for moving the item 430 for Jazzy Juice, which the user has already passed, to the wallet 443 for subsequent retrieval.

Also presented are MAP VIEW and DIRECTIONS action buttons 445 and 447 respectively. Selection of the Map View action button enables the user to switch from the “Multimedia Information View” to a “Map View.” Selection of the DIRECTIONS action button 447 enables the user to switch from the “Multimedia Information View” to a “Turn-By-Turn Directions View.”

It is noted that the above described location based items are presented as an alternative to graphic depictions of buildings, landmarks, icons and other information for representing certain POI. Also, it is noted that while described above as distinct location based items (e.g., item 431, item 432), the various icons (e.g., icon 449), textual captions (e.g., caption 451), frames (e.g., frame 437a), etc., are elements of the multimedia information in its entirety. As such, the multimedia information as presented to the interface 425 is interactive as well as depicted as moving/scrolling across the interface 425 relative to the movement of the user along the route. Under this scenario, the interface 425 may be refreshed and/or the multimedia information adapted accordingly to account for changes in the direction of the user, the speed of the user, activities of the user, etc.

The processes described herein for enabling a user to view multimedia information associated with a route may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

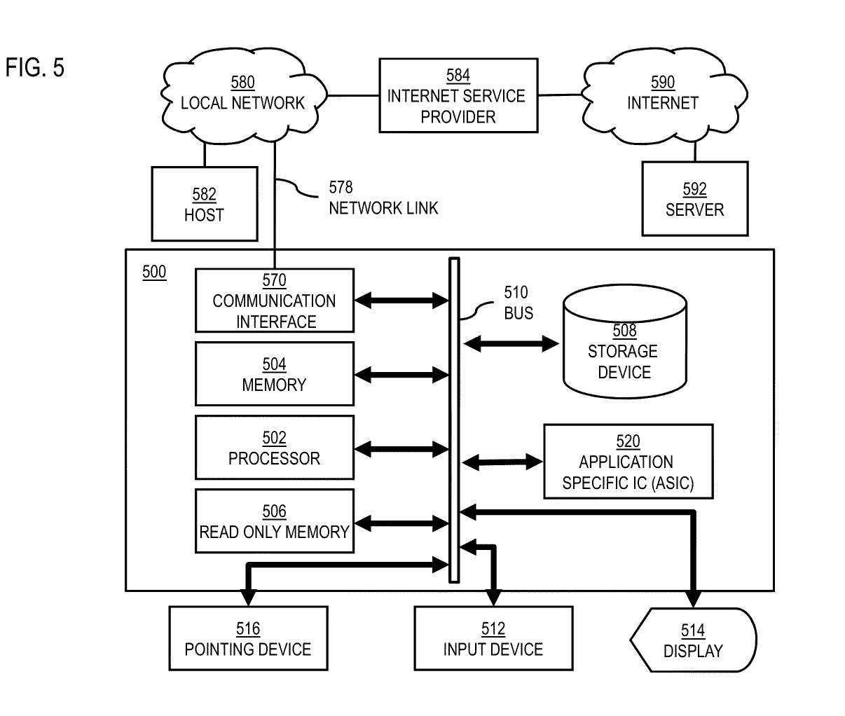

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to enable a user to view multimedia information associated with a route as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of enabling a user to view multimedia information associated with a route.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to enable a user to view multimedia information associated with a route. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for enabling a user to view multimedia information associated with a route. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for enabling a user to view multimedia information associated with a route, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for enabling a user to view multimedia information associated with a route to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to enable a user to view multimedia information associated with a route as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of enabling a user to view multimedia information associated with a route.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to enable a user to view multimedia information associated with a route. The memory 605 also stores the data associated with or generated by the execution of the inventive steps.

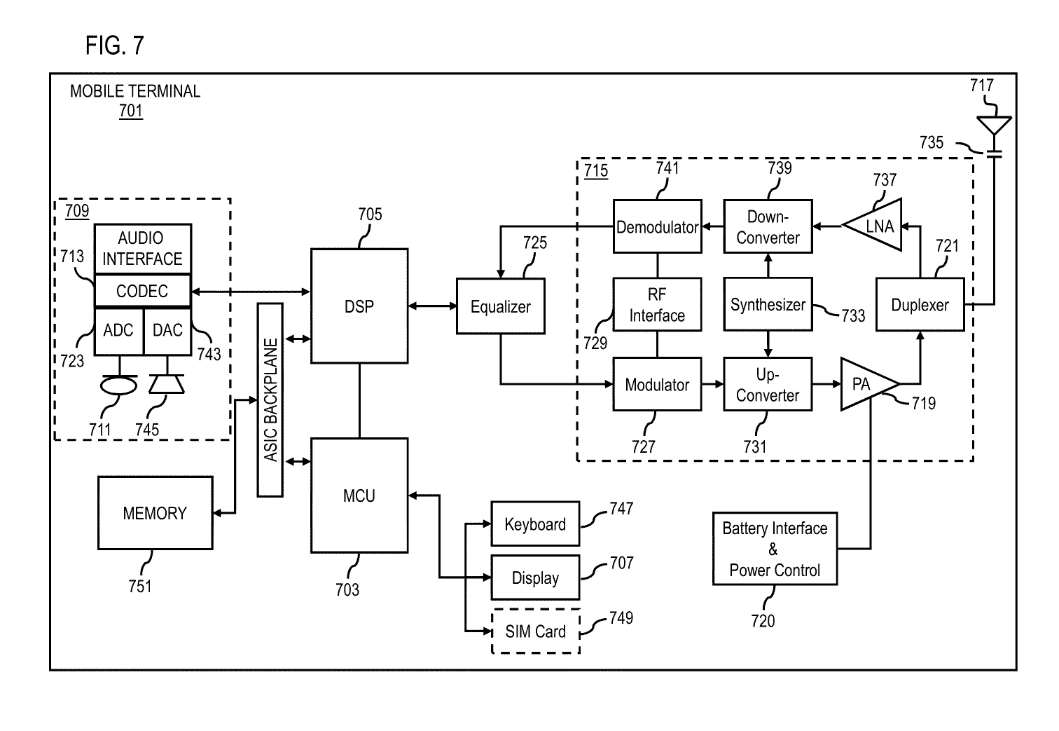

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of enabling a user to view multimedia information associated with a route. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of enabling a user to view multimedia information associated with a route. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to enable a user to view multimedia information associated with a route. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
an input for selecting at least one route associated with at least one device;
at least one determination of multimedia information associated with the at least one route; and
a presentation of the multimedia information in place of mapping information, navigation information, or a combination thereof associated with the at least one route.

2. A method of claim 1, wherein the (1) data and/or (2) information and/or (3) at least one signal are further based, at least in part, on the following:
at least one determination that the at least one route is selected from among one or more previously entered routes.

3. A method of claim 1, wherein the (1) data and/or (2) information and/or (3) at least one signal are further based, at least in part, on the following:
at least one determination of advertising information, offer information, promotional information, user interest information, or a combination thereof associated with the at least one route, one or more points of interest associated with the at least one route, or a combination thereof,
wherein the advertising information, the offer information, the promotional information, user interest information, or a combination thereof comprise, at least in part, the multimedia information.

4. A method of claim 1, wherein the wherein the multimedia information includes, at least in part, one or more location-based items, the method further comprising (1) data and/or (2) information and/or (3) at least one signal are further based, at least in part, on the following:
a presentation of the one or more location-based items based, at least in part, on location information associated with the at least one device.

5. A method of claim 4, wherein the (1) data and/or (2) information and/or (3) at least one signal are further based, at least in part, on the following:
a rendering of a user interface for depicting a scrolling of the multimedia information, a movement of the multimedia information, a scrolling of the one or more location-based items, a movement of the one or more location-based items, or a combination thereof,
wherein the presentation of the multimedia information includes, at least in part, the rendering of the user interface

6. A method of claim 4, wherein the (1) data and/or (2) information and/or (3) at least one signal are further based, at least in part, on the following:
at least one determination of a timing, a duration, or a combination thereof for presentation of the multimedia information, the one or more location-based items, or a combination thereof based, at least in part, on contextual information associated with the at least one device, the at least one route, the multimedia information, the one or more location-based items, a mode of travel, or a combination thereof.

7. A method of claim 4, wherein the (1) data and/or (2) information and/or (3) at least one signal are further based, at least in part, on the following:
at least one determination of a timing, a duration, or a combination thereof for presentation of the one or more location-based items based, at least in part, on a physical proximity, a temporal proximity, or a combination thereof of the at least one user to the one or more location-based items.

8. A method of claim 6, wherein the location information includes, at least in part, a current location of the at least one device, a predicted location of the at least one device, or a combination thereof.

9. A method of claim 1, wherein the (1) data and/or (2) information and/or (3) at least one signal are further based, at least in part, on the following:
at least one determination of an accessibility of the multimedia information, the one or more location-based items, or a combination thereof with respect to the at least one device based, at least in part, on the location information,
wherein the presentation of the multimedia information, the one or more location-based items, or a combination thereof is based, at least in part, on the accessibility.

10. A method of claim 1, wherein the (1) data and/or (2) information and/or (3) at least one signal are further based, at least in part, on the following:
a recommendation of the at least one route, one or more other routes, or a combination thereof based, at least in part, on an availability of the multimedia information on the at least one route, the one or more other routes, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine an input for selecting at least one route associated with at least one device;
determine multimedia information associated with the at least one route; and
cause, at least in part, a presentation of the multimedia information in place of mapping information, navigation information, or a combination thereof associated with the at least one route.

12. An apparatus of claim 11, wherein the apparatus is further caused to:
determine that the at least one route is selected from among one or more previously entered routes.

13. An apparatus of claim 11, wherein the apparatus is further caused to:
determine advertising information, offer information, promotional information, user interest information, or a combination thereof associated with the at least one route, one or more points of interest associated with the at least one route, or a combination thereof,
wherein the advertising information, the offer information, the promotional information, user interest information, or a combination thereof comprise, at least in part, the multimedia information.

14. An apparatus of claim 11, wherein the multimedia information includes, at least in part, one or more location-based items, wherein the apparatus is further caused to:
cause, at least in part, a presentation of the one or more location-based items based, at least in part, on location information associated with the at least one device.

15. An apparatus of claim 14, wherein the apparatus is further caused to:
cause, at least in part, a rendering of a user interface for depicting a scrolling of the multimedia information, a movement of the multimedia information, a scrolling of the one or more location-based items, a movement of the one or more location-based items, or a combination thereof,
wherein the presentation of the multimedia information includes, at least in part, the rendering of the user interface.

16. An apparatus of claim 14, wherein the apparatus is further caused to:
determine a timing, a duration, or a combination thereof for presentation of the multimedia information, the one or more location-based items, or a combination thereof based, at least in part, on contextual information associated with the at least one device, the at least one route, the multimedia information, the one or more location-based items, a mode of travel, or a combination thereof.

17. An apparatus of claim 14, wherein the apparatus is further caused to:
determine a timing, a duration, or a combination thereof for presentation of the one or more location-based items based, at least in part, on a physical proximity, a temporal proximity, or a combination thereof of the at least one user to the one or more location-based items.

18. An apparatus of claim 14, wherein the location information includes, at least in part, a current location of the at least one device, a predicted location of the at least one device, or a combination thereof.

19. An apparatus of claim 11, wherein the apparatus is further caused to:
determine an accessibility of the multimedia information, the one or more location-based items, or a combination thereof with respect to the at least one device based, at least in part, on the location information,
wherein the presentation of the multimedia information, the one or more location-based items, or a combination thereof is based, at least in part, on the accessibility.

20. An apparatus of claim 11, wherein the apparatus is further caused to:
cause, at least in part, a recommendation of the at least one route, one or more other routes, or a combination thereof based, at least in part, on an availability of the multimedia information on the at least one route, the one or more other routes, or a combination thereof.

21-48. (canceled)
